(19) United States
(12) Patent Application Publication
(10) Pub. No.: US 2026/0265463 A1
(43) Pub. Date: Sep. 10, 2026

(54) NON-HALOGENATED FIRE RESISTANT COATINGS

(71) Applicant: The Government of the United States of America, as represented by the Secretary of the Navy, Arlington, VA (US)

(72) Inventors: Arthur A. Webb, Bethesda, MD (US); Bruce A. Connelly, Gibsonia, PA (US)

(73) Assignee: The Government of the United States of America, as represented by the Secretary of the Navy, Arlington, VA (US)

(21) Appl. No.: 19/558,668

(22) Filed: Mar. 6, 2026

Related U.S. Application Data
(60) Provisional application No. 63/768,220, filed on Mar. 7, 2025.

(51) Int. Cl. C08G 77/54; C07F 7/18; C09D 183/14

(52) U.S. Cl. CPC C08G 77/54; C07F 7/1892; C09D 183/14

(57) ABSTRACT

Disclosed herein is the silicate compound below, its synthesis method, and the intermediates made by the method. The silicate compound is made by reacting an alkyl acrylate/3-aminopropyl trimethoxysilane adduct with isophorone diisocyanate, reacting with tetraethyl orthosilicate or a hydrolyzed tetraethyl orthosilicate to form a polysiloxane resin, and curing to form a silicate compound.

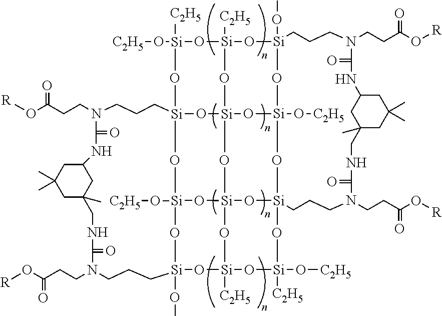

### REFERENCE TO RELATED APPLICATIONS

This application claims the benefit of U.S. Provisional Application No. 63/768,220, filed on Mar. 7, 2025. The provisional application and all other publications and patent documents referred to throughout this nonprovisional application are incorporated herein by reference.

### TECHNICAL FIELD

The present disclosure is generally related to fire resistant coatings.

### DESCRIPTION OF THE RELATED ART

The U.S. Navy presently employs fire resistant coatings to all habitability and machinery spaces aboard all ships and submarines. These coatings consist of two different products designed to resist combustion during a fire situation and also formulated to be non-flaming, i.e., they will not support sustained combustion. However, it has been well documented that under any shipboard fire there are certain conditions and situations where these coatings will burn. Under these conditions, the coatings when ignited, release a wide series of toxic products to include dioxin, hydrochloric acid, and perchlorates. As in most shipboard fires, it is not the fire itself that results in fatalities, but rather it is the smoke and toxic fumes release from burning materials (i.e. coatings) that result in severe injuries and or fatalities. The standard MIL-DTL-24607 chlorinated alkyd will burn albeit to a lesser degree than a normal coating but in this process, copious quantities of heavy smoke and halogens are released.

Although rare within the U.S. Navy, shipboard fires can have disastrous consequences. The fire on the USS Stark in May 1987 as a result of a missile strike, burned for nearly 24 hours wherein 29 men were killed in the explosion and resultant fire, the majority of the fatalities were primarily due to smoke inhalation and the toxic constituents from burning paint, insulation and other polymeric materials. Recently the shipboard fire on the USS Miami was supported primarily by interior coatings, insulation and other polymeric materials after the initial combustion source was exhausted.

FIG. 1 illustrates a typical structure of a chlorinated alkyd resin. Chlorinated non-flaming paints have been an industry standard for shipboard interior coatings for more than 40 years and have, in most cases, provided adequate performance provided that they are fully dry and not applied at excessive thickness. However, based on several environmental and health and safety concerns, coatings containing halogenated resins are becoming increasingly more costly to produce. For example, chlorinated alkyd resins are synthesized by copolymerization of a normal vegetable oil triglyceride with pentaerthritol/glycerol and chlorendic anhydride. The resultant resin contains roughly 16 percent halogenated organic (chlorendic anhydride) and 84 percent vegetable oil fatty acid ester. The total chlorine content is approximately 8-12 percent depending on the ratio of oil/pentaerthritol/glycerol/chlorendic anhydride when resin is produced. Nevertheless, the resin contains a substantial proportion of combustible fatty acid which will burn. Furthermore, the low crosslink density of alkyd type coatings results in a significant proportion of the coating melting and dripping leading to released vaporized and readily flammable material.

Although chlorinated alkyds are the predominant shipboard interior non-flaming coating, there is another system that is employed when the use of chlorinated alkyds is not desired or possible. FIG. 2 illustrates a typical chlorinated vinyl resin, as is employed as a waterborne latex-type system. Chlorinated vinyl resins are primarily employed where low odor and lower solvent content are required by regulation. However, the vinyl based resins have 60-65 percent chlorine by weight and therefore have higher release potential than the alkyd based system. Furthermore, being waterborne, the coatings are often problematic when they applied in poorly ventilated shipboard interior spaces where relative humidity levels are high. Given that the coating hardens by water (and solvent) evaporation and particle coalescence, this type of coating may remain wet and easily damaged for several days or more depending on ventilation refresh rate, temperature and relative humidity. Furthermore, the chlorinated vinyl systems are generally much softer and more easily damaged than a fully dried chlorinated alkyd system.

Noting the physical attributes desired for a shipboard interior coating most importantly, gloss, durability, ease of cleaning, general overall aesthetics, and non-flaming performance, the development of a system with same performance without using halogenated resins is challenging. Although there is high temperature silicone based coatings, they are a high solvent containing a blend of acrylic and silicone resin wherein the acrylic serves as the primary binder holding the silicone resin in place. When heated to 200-300° F., the acrylic resin is vaporized off and the silicone cross-links form a fairly robust, durable film with excellent non-flaming characteristics. However, until heated for cure, the coating is essentially uncured and is easily damaged. There are pure silicone systems as well, but again, they must be heated to force curing of the resin, an operation that is impractical for large structures. Unlike traditional organic coatings, silicone systems possess outstanding thermal resistance and in most cases will resist continuous operation in excess of 700° F. and specialized systems will maintain their appearance and durability after thermal excursions up to 1,200° F. which is perhaps far hotter than any shipboard fire under all but the most extreme circumstances.

### SUMMARY OF THE INVENTION

Disclosed herein is a compound having the formula below. Each R is an alkyl group.

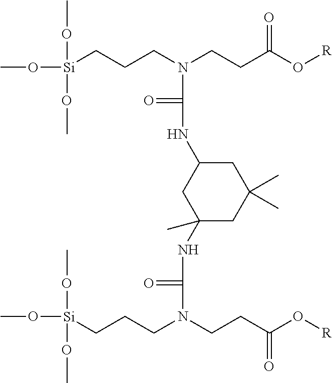

Also disclosed herein is a polysiloxane resin having the formula below. Each R is an alkyl group, and each n is a non-negative integer.

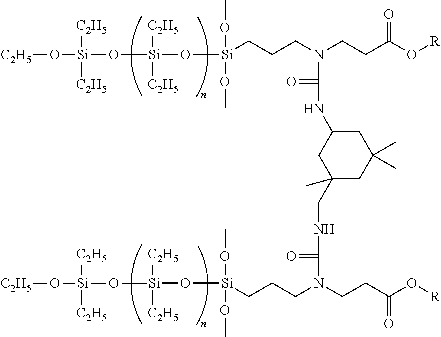

Also disclosed herein is a silicate compound having the formula below. Each R is an alkyl group, and each n is a non-negative integer.

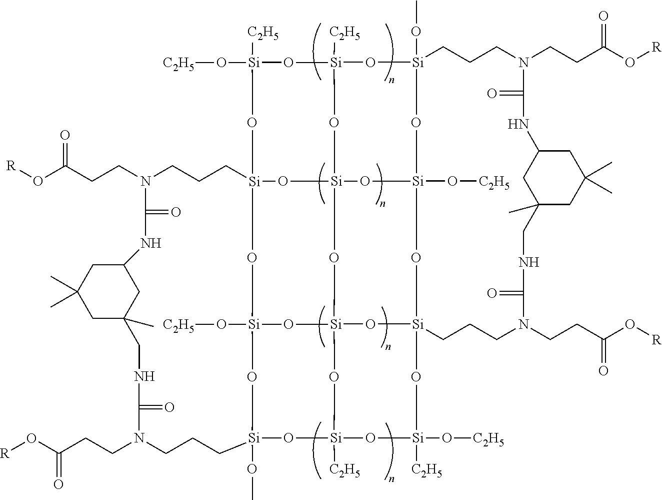

Also disclosed herein is a method comprising reacting an alkyl acrylate/3-aminopropyl trimethoxysilane adduct with isophorone diisocyanate to form the compound above.

### BRIEF DESCRIPTION OF DRAWINGS

A more complete appreciation will be readily obtained by reference to the following Description of the Example Embodiments and the accompanying drawings.

FIG. 1 shows a typical structure of a prior art chlorinated alkyd resin showing the halogenated (chlorendic anhydride) component on the left. The resin is ~80 wt % combustible organic.

FIG. 2 shows a prior art chlorinated vinyl resin.

FIG. 3 shows the synthesis of polysiloxane resin adduct from amino-silane and butyl acrylate.

FIG. 4 shows polysiloxane resin synthesis by combining adducts together using isophorone diisocyanate.

FIG. 5 shows a hydrolysis process for TEOS.

FIG. 6 shows combining TEOS with polysiloxane resin to form the final resin for coating.

FIG. 7 shows the hardened coating. Under fire conditions the R group is burned off leaving only the inorganic silicate.

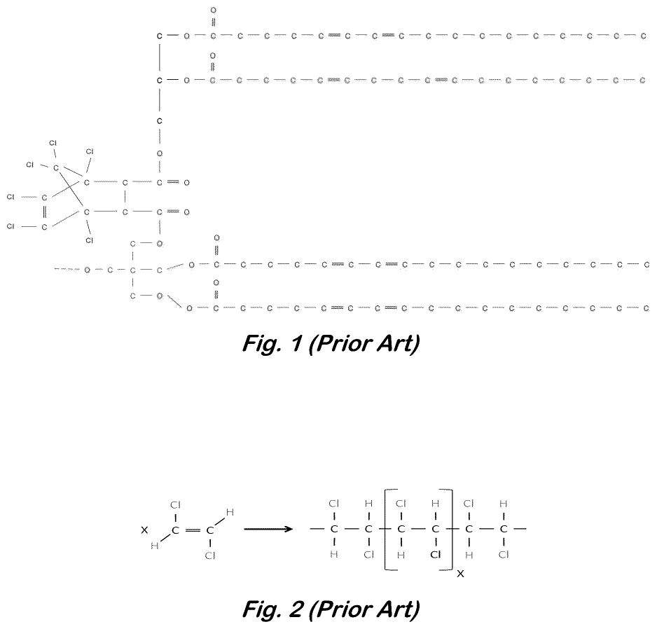

### DETAILED DESCRIPTION

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein are a series of single component polysiloxane based non-flaming coatings (1K FRC). Thus far the coatings perform as well as the U.S. Navy's current MIL-DTL-24607 chlorinated alkyd. However, unlike traditional non-flaming coatings which contain halogenated constituents or copolymers, the new system relies on the inherent fire resistance of polysiloxane resins for performance and, where needed, can incorporate non-halogenated additives and reactive diluents. The new systems have the handling, application, and general overall appearance of a traditional high performance high gloss/semi-gloss coating but with the convenience of single component application and drying.

In recent years there has been considerable industrial producer activity in the realm of functional materials based on siloxanes and silanes. Within the past decade both the volume and variety of near commodity grade functional siloxanes and silanes have grown considerably. Once considered as high cost low volume use materials employed in such applications as adhesion promotion and for specialized surface effects (water repellency), there has been a significant growth in the production and development of lower cost functional silanes and siloxanes which in themselves can be employed almost directly as a binder for coatings. Taking advantage of the now lower cost raw materials, a series of 1K polysiloxane coatings have been developed, which 1) are cost competitive to traditional high performance systems such as polyurethanes and 2) exhibit performance properties which are unique to siloxanes but also of traditional organic systems, namely gloss, and overall appearance. Spurred by the successful development and fielding of polysiloxane-based weather resistant topcoats ad nonskid coatings for U.S. Navy Shipboard use, work began to focus on the development of a fire resistant and or non-flaming coatings using similar polysiloxane chemistry.

The approach taken in the development of polysiloxane-based non-flaming coatings began with the premise of possibly eliminating the current halogenated non-flaming shipboard interior coatings from the U.S. Navy's inventory. There has been a push to find alternatives to the legacy coatings employed in shipboard interior spaces. Alternatively, a coating based on a higher percentage of inorganic moieties could perform the same if not better without the need for halogenated resins or compounds. The non-flaming performance of silicone coatings is well known but as previously discussed, these coatings are impractical for shipboard interior coatings in their current commercial forms. As such, a series of alkoxyfunctional polysiloxane resins were developed, which can be co-reacted with organic resins to produce a single component (air dry) non-flaming interior coating which looks and handles just like the current chlorinated organic systems. Furthermore, these polysiloxane systems can be reacted with low cost functional silicone resins to produce a further enhanced system with all the application and handling properties of a traditional single component organic resin-based coating. The percentage of organic to inorganic component in these newly developed 1K polysiloxane coatings can be varied widely to balance cost and performance depending on the actual area of use. Furthermore, it has been demonstrated that these newly developed polysiloxane coatings have notable adhesion to aluminum and as such their use is being investigated as a possible replacement for 2K and 1K polyurethanes for aircraft.

The basis of the polysiloxane coatings begins with functional silanes. The binder systems are developed from commercially available alkyl-silanes commonly employed as an adhesion promoters for coatings specifically for steel, aluminum and glass. Traditionally employed at 1-2% of the total volume of a traditional coating binder, these specific silanes have a dramatic effect on system adhesion. In their neat state these silanes will react with airborne moisture and condense to form a polysiloxane but lack mechanical strength, are friable and easily damaged. In order to promote mechanical strength, the silanes are co-reacted with a functional organic material to provide enhanced toughness and durability. For example, reacting the silanes with functional organic compounds results in a “base adduct” consisting of organic moiety terminated silanes. This base adduct in itself possesses very low viscosity and is suitable as a binder for coatings but is highly reactive toward atmospheric moisture and the silanes will readily condense with one another to form a very hard and brittle product. However, the thermal resistance of the base adduct is remarkable. Although possessing a nearly 60% organic structure, coatings made from the base adduct alone are highly resistant to both direct and indirect flame impingement.

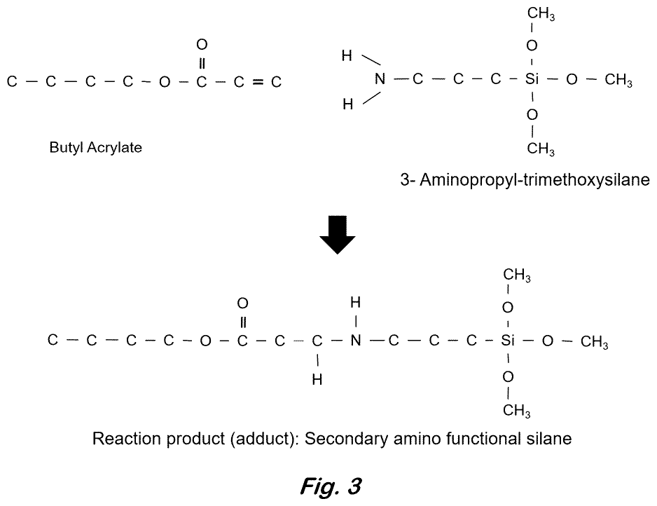

The base adduct is made by reacting an alkyl acrylate with 3-aminopropyl trimethoxysilane as shown in FIG. 3. Conditions for performing such reactions are known in the art. FIG. 3 shows the use of butyl acrylate, but other alkyl acrylates, such as methyl acrylate may be used.

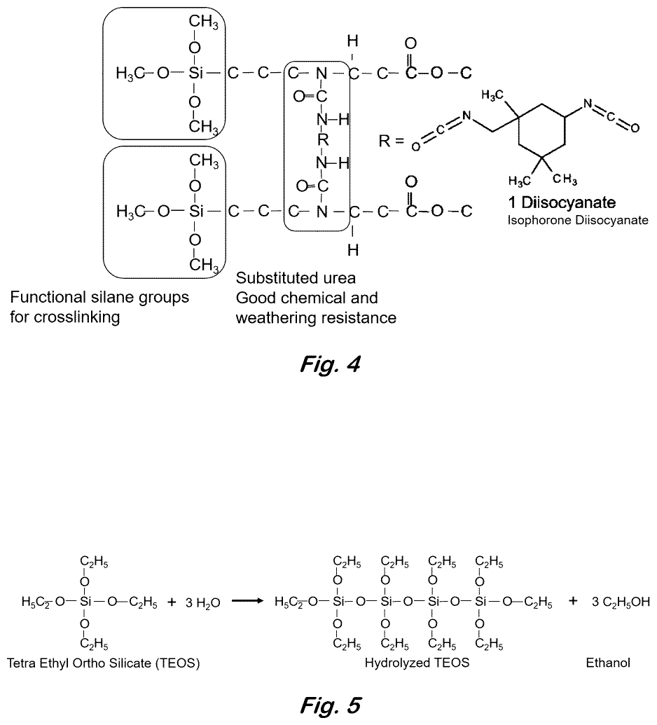

In a next step, the adduct is reacted with isophorone diisocyanate as shown in FIG. 4. Conditions for performing such reactions are known in the art. Isophorone diisocyanate has 20% less organic composition than xylylene diisocyanate, which is commonly used in other such products.

To complement the inherent non flaming or fire resistant properties of a polysiloxane resin, the use of tetraethyl orthosilicate (TEOS) is also employed. Although TEOS itself is flammable, when fully condensed (i.e. all the ethanol has been removed) it is a hard inorganic silicate with no available organic material available for combustion. TEOS is bulk commodity material and therefore readily available and an economical constituent for incorporation into a coating.

Initially all of the TEOS employed in the binder portion of the coating was prehydrolyzed prior to combining with the polysiloxane resin (FIG. 5). The TEOS was prehydrolyzed by adding one mole of water to one mole of TEOS and adding 0.01% hydrochloric acid (HCL) and stirring vigorously until the TEOS began to react with the water. The reaction would occur in two distinct steps. Step one was the initial hydrolyzation of the first ethyl group of the TEOS molecule, then approximately 40 to 50 seconds later the second ethyl group would hydrolyze. At this point the TEOS molecule is effectively hydrolyzed and a linear molecule of hydrolyzed TEOS is generated. The material was stabilized using 10% butanol. The total reaction time is about 15-20 minutes and to speed the uptake of water (enhance the solubility of water in the TEOS for conversion) a few percent of methanol is added.

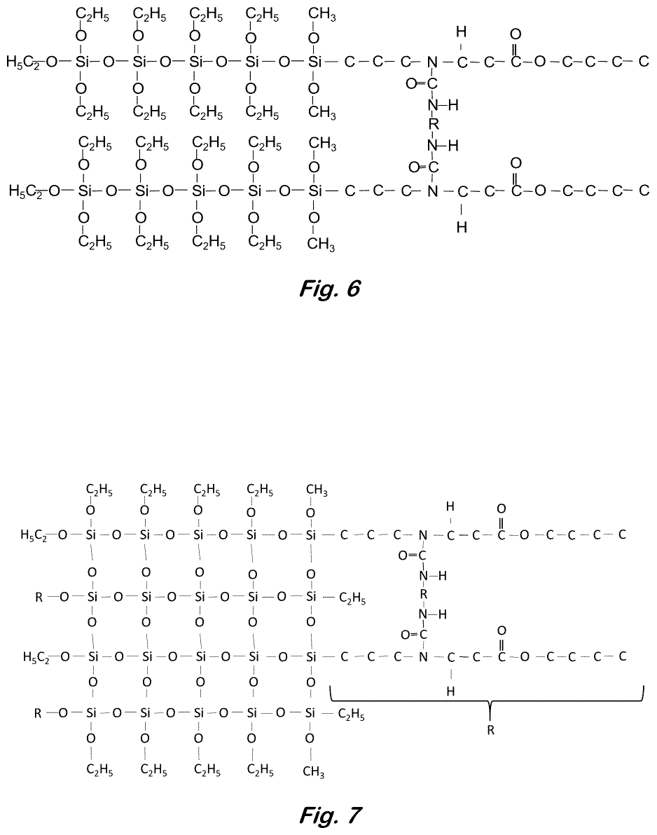

The hydrolyzed TEOS is then combined with the polysiloxane resin and co-condensed to produce a hybrid TEOS-polysiloxane binder system with an average of 80% hydrolyzed silicate (FIG. 6). Conditions for performing such reactions are known in the art. The general structure for the resin is shown below. Suitable R groups include, but are not limited to, methyl and butyl. The value n may be, for example, 3.

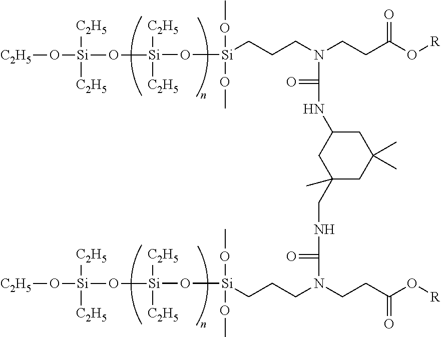

Alternatively, 3-aminopropyl methyldimethoxysilane may be used as a chain extender to promote less dense crosslinking. The chain extender is reacted with the 3-aminopropyl trimethoxysilane/butyl acrylate/isophorone compound to add between the methoxy groups on adjacent trimethoxy silanes.

The resin may be combined with pigments and fillers to produce the final coating system. The coating hardens through the reaction of the silicate with moisture in the air and forms a dense network of crosslinked silicate which produces a hard durable film (FIG. 7). When exposed to fire, the organic portion of the binder material burns off leaving only the silicate thus producing a wholly inorganic non-combustible coating. A general structure is shown below.

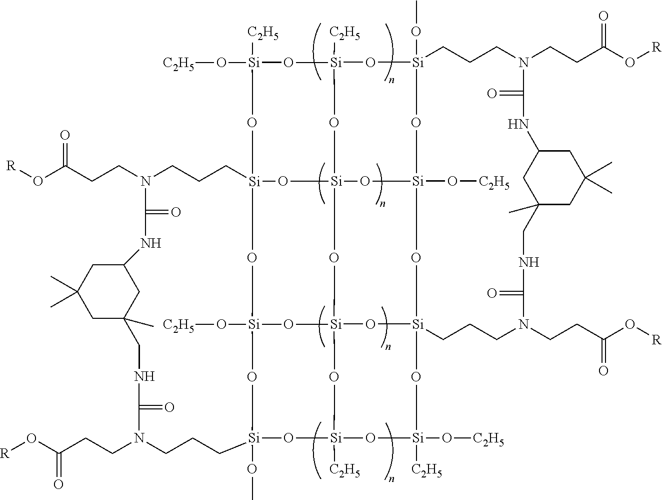

Although the synthesis of the polysiloxane binder is straight forward, the production of the hydrolyzed TEOS was not. Nearly half the time during the hydrolyzation process, the TEOS would gel and form an insoluble mass. In other instances, a clear liquid with a sharp ethanol odor would be produced, only to gel within a few hours. The addition of methanol and or n-butanol would effectively stabilize the material for up to a period of about 2 weeks. After that the samples would begin to gel. The original concept was to employ the prehydrolyzed TEOS as a means of generating a coating that would have a reasonable cure time of approximately 4-6 hours. This is because hydrolyzed TEOS is more reactive to airborne moisture and because it is already partially polymerized, the material polycondenses very quickly into a solid film former. However, it was difficult to produce coatings with any reasonable storage stability. Moisture present within the pigments and fillers quickly reacted with the hydrolyzed TEOS and effectively gelled the coating before it could be applied. In order to alleviate the moisture problem, all pigments were heated overnight in the oven at 110° C. to remove residual moisture. This approach was effective in increasing the storage stability of the coatings but also added an additional step in the formulation process. Also, although the storage stability was lengthened, the coatings still did not remain in the liquid state for more than 25-30 days and this duration was significantly shortened once the container was opened. Because of these problems, it was elected to abandon the use of prehydrolyzed TEOS and simply employ unreacted TEOS. As a result, the system demonstrated a significant increase in storage stability and negated the need to dry the pigments and fillers. Sample retains of neat resin have remained in the liquid state for durations of more than 10 months and are still useable.

The films produced by the polysiloxane-TEOS hybrid resin are durable, hard and have excellent gloss. The flexibility of the system is determined by the amount of organic contribution made by the polysiloxane part of the system. However, the higher the percentage of organic moieties also reduces the system's ability to resist combustion. Polysiloxane made using butyl acrylate is indeed more flexible than a corresponding polysiloxane made using methyl acrylate which is less than half the size of butyl acrylate. However, the methyl acrylate system is far better at fire resistance and produces less smoke as the organic component burns off when heated to extreme temperatures.

Initially the storage stability of the binder was short and when formulated into a coating, moisture present in pigments and additives causes significant reduction in shelf life. Samples made from the adduct and pigmented with inorganic pigments such as titanium dioxide (TiO₂) and iron oxides remain as liquids for only two to three days before gelling. Again, this was because of the original use of prehydrolyzed TEOS.

An improvement in system handling properties, storage stability as well as system appearance can be achieved by coupling the base adduct (the polysiloxane) with a functional inorganic material such as non-hydrolyzed TEOS or a functional silicone resin. As a result, the “coupled adduct” binder or resin has a more bodied consistency. The resulting resin contains a small portion of organic product capable of producing films with the gloss, leveling, durability and toughness of an organic system and the fire resistance and adhesion performance of a polysiloxane.

Further enhancements of the system performance to include adhesion, flexibility and fire resistance can be made by blending in varying degrees of polysilicate. In addition, the polysilicate significantly reduces the product viscosity and aids in system curing. The level of polysilicate is however important in that too little offers no improvement and too much can result in incompatibility and ultimately gelling of the formulation after only a few hours. Again, this problem was alleviated by no longer using prehydrolyzed TEOS. The polysilicate blended systems are extremely hard and scratch resistant, moderately flexible and very resistant to solvents. The coatings are unaffected by acetone and methylethylketone, and samples immersed in aircraft hydraulic fluid show no signs of degradation or change in appearance after nearly 5 months. These are ideal attributes for a coating being designed for shipboard interior spaces.

Laboratory batches have been produced using various formulations, each with a desire to maximize the aesthetics of the coating (i.e., gloss) and to provide a system with the lowest smoke generation and highest resistance to ignition properties. The formulations vary in composition employing different percentages of adduct, coupled adducts (both organic and silicone coupled) as well as with and without polysilicate addition. In general, the base formulation comprises of the organic coupled adduct as the starting formula and then varying levels of base adduct or polysilicate or both are added. As such various formulae have been developed each with a slightly different variation. Test coupons consist of 2.5″×6.0″×0.015″ aluminum panels to which the candidate systems are applied and allowed to dry for 7 days prior to screening. Fire resistance screening tests consist of placing the coated panels in a ring stand clamp over a portable butane torch and observing the performance of the coating as it is exposed to both the front and the back in the flame. The flame temperature of the torch is roughly 920° F. and panels are held in place until no more observable changes occur during the test or roughly 20 seconds. Typically, the coatings begin to discolor within 3 seconds and then progresses from a tan to near black in about 10 seconds. In some instances, there may be a slight flash of blue flame for less than 1 second and a small quantity of white smoke for a few seconds, but as the test continues, these events cease. For the remaining 10-20 seconds the coatings (depending on their exact formulation) simply discolor from brown to black or remain only slightly discolored. A few formulations simply begin to craze and immediately fall off the panel after 10-15 seconds without any discoloration or product combustion.

Thus far the systems discussed herein have all demonstrated the ability to resist combustion and have clearly exhibited significantly less smoke therefore tending to show that these new products will be inherently safer than the current legacy material.

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

What is claimed is:

1. A compound having the formula: 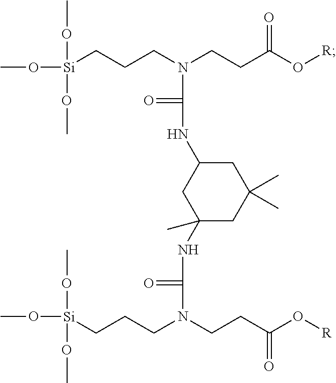
wherein each R is an alkyl group.

2. The compound of claim 1, wherein each R is a methyl group.

3. The compound of claim 1, wherein each R is a butyl group.

4. A polysiloxane resin having the formula: 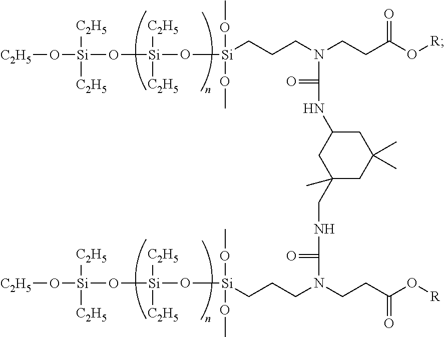
wherein each R is an alkyl group; and
wherein each n is a non-negative integer.

5. The polysiloxane resin of claim 4, wherein each R is a methyl group.

6. The polysiloxane resin of claim 4, wherein each R is a butyl group.

7. The polysiloxane resin of claim 4, wherein each n is 3.

8. A coating composition comprising the polysiloxane resin of claim 4.

9. A silicate compound having the formula: 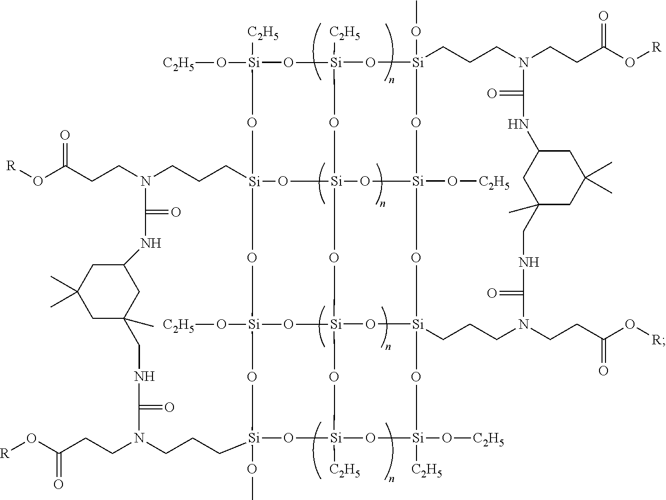
wherein each R is an alkyl group; and
wherein each n is a non-negative integer.

10. The silicate compound of claim 9, wherein each R is a methyl group.

11. The silicate compound of claim 9, wherein each R is a butyl group.

12. The silicate compound of claim 9, wherein each n is 3.

13. A method comprising:
reacting an alkyl acrylate/3-aminopropyl trimethoxysilane adduct with isophorone diisocyanate to form a compound having the formula: 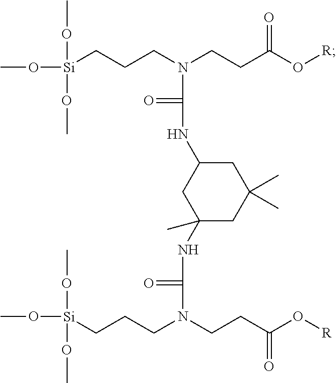
wherein each R is an alkyl group.

14. The method of claim 13, wherein each R is a methyl group.

15. The method of claim 13, wherein each R is a butyl group.

16. The method of claim 13, further comprising:
reacting the compound with tetraethyl orthosilicate or a hydrolyzed tetraethyl orthosilicate to form a polysiloxane resin having the formula: 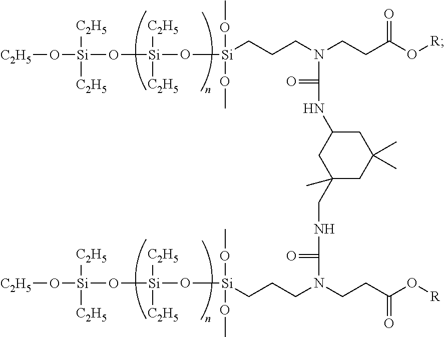
wherein each n is a non-negative integer.

17. The method of claim 16, wherein each n is 3.

18. The method of claim 16, further comprising:
curing the polysiloxane resin to form a silicate compound having the formula:

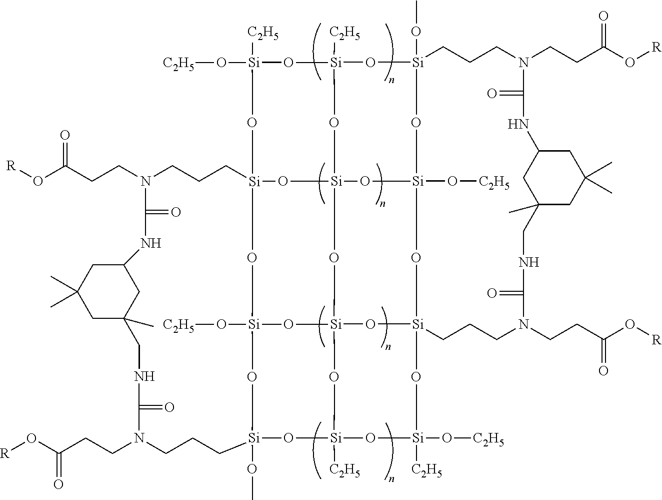

19. The method of claim 18, wherein the curing forms a coating.

20. The coating made by the method of claim 19.

21. The method of claim 13, further comprising:
reacting the compound with 3-aminopropyl methyldimethoxysilane to form a second compound;
reacting the second compound with tetraethyl orthosilicate or a hydrolyzed tetraethyl orthosilicate to form a polysiloxane resin;
curing the polysiloxane resin to form a silicate compound.

22. The silicate compound made by the method of claim 21.
